(19) United States
(12) Patent Application Publication
(10) Pub. No.: US 2019/0303037 A1
(43) Pub. Date: Oct. 3, 2019

(54) USING SEQUENTIAL READ INTENTION TO INCREASE DATA BUFFER REUSE

(71) Applicant: CA, Inc., Islandia, NY (US)

(72) Inventor: Richard Stephen Williamson, Plano, TX (US)

(73) Assignee: CA, Inc., Islandia, NY (US)

(21) Appl. No.: 15/941,755

(22) Filed: Mar. 30, 2018

(51) Int. Cl. G06F 3/06

(52) U.S. Cl. CPC G06F 3/0656; G06F 3/0673; G06F 3/0608

(57) ABSTRACT

Aspects of the embodiments include a computer-implemented method including identifying one or more data buffer locations from a least recently used (LRU) buffer pool structure for writing data into a data buffer; writing data into the identified one or more data buffer locations; reading the data from the one or more data buffer locations; and assigning the one or more data buffer locations to a least recently used buffer locations in the LRU.

### FIELD

This disclosure pertains to using sequential read intentions to increase data buffer reuse.

### BACKGROUND

Mainframe computers can act as a central data repository, or hub, in a data processing center, and can be connected to users through less powerful devices, such as workstations or terminals. Mainframe computers can make use of relational databases, or other forms of databases, to organize information quickly. A relational database can use a structured query language (SQL) to query and maintain the database.

SQL server buffer pool, also called an SQL server buffer cache, is a place in system memory that is used for caching table and index data pages as they are modified or read from a disk or other main storage. The SQL buffer pool can reduce database file input/output and improve the response time for data retrieval.

### SUMMARY

Aspects of the embodiments include a computer-implemented method including identifying one or more data buffer locations from a least recently used (LRU) buffer pool structure for writing data into a data buffer; writing data into the identified one or more data buffer locations; reading the data from the one or more data buffer locations; and assigning the one or more data buffer locations to a least recently used buffer locations in the LRU.

Aspects of the embodiments include a non-transitory computer-readable medium having program instructions stored therein, wherein the program instructions are executable by a computer system to perform operations that include identifying one or more data buffer locations from a least recently used (LRU) buffer pool structure for writing data into a data buffer; writing data into the identified one or more data buffer locations; reading the data from the one or more data buffer locations; and assigning the one or more data buffer locations to a least recently used buffer locations in the LRU.

Aspects of the embodiments include a system that can include a hardware processor; and a memory coupled to the hardware processor, the memory for storing data. The hardware processor to identify one or more data buffer locations from a least recently used (LRU) buffer pool structure for writing data into a data buffer; write data into the identified one or more data buffer locations; read the data from the one or more data buffer locations; and assign the one or more data buffer locations to a least recently used buffer locations in the LRU.

Some embodiments can include determining that new data is to be read into the data buffer; identifying the one or more least recently used buffer locations in the LRU; flushing data contained in the identified one or more least recently used buffer locations; and reading the new data into the data buffer at the data buffer locations identified as one or more least recently used buffer locations in the LRU.

Some embodiments can include reading one or more indexes from an index buffer pool to identify one or more data records in response to a request for data; determining, based on the one or more indexes, that the one or more data records is not present in the data buffer; and retrieving the one or more data records from a storage device for reading into the data buffer.

In some embodiments, reading one or more indexes includes performing a read ahead of the one or more indexes from the index buffer pool; and determining that the data to be read is organized as sequential data blocks.

In some embodiments, the sequential data blocks comprise a plurality of sequentially organized rows of data; and the method can include identifying a number of sequential rows in the data buffer for writing the sequentially organized rows of data; and after the sequentially organized rows of data are read from the data buffer, assigning the number of sequential rows as least recently used within the LRU.

Some embodiments can include assigning the identified one or more data buffer locations to a most recently used position in the LRU prior to reading the data from the identified one or more data buffer locations; and assigning the one or more data buffer locations to the least recently used buffer locations in the LRU can include assigning the one or more data buffer locations to the least recently used buffer locations after reading all of the data from the identified one or more data buffer locations.

### BRIEF DESCRIPTION OF THE DRAWINGS

FIG. 1 is a schematic block diagram of an example computing system that includes a buffer pool in accordance with embodiments of the present disclosure.

FIG. 2 is a schematic block diagram of a relational database management system that includes a least recently used list in accordance with embodiments of the present disclosure.

FIG. 3 is a process flow diagram for implementing a dynamic buffer pool to process non-conforming tasks in accordance with embodiments of the present disclosure.

FIG. 4 is a process flow diagram for using sequential read-ahead intention for increasing data buffer reuse in accordance with embodiments of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA.R™, SCALA.™, SMALLTALK™, EIFFEL™, JADE™, EMERALD™, C++, C#, VB.NET, PYTHON™ or the like, conventional procedural programming languages, such as the “C” programming language, VISUAL BASIC™, FORTRAN™ 2003, Perl, COBOL 2002, PHP, ABAP™, dynamic programming languages such as PYTHON™, RUBY™ and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

A data buffer pool can use a Least Recently Used (LRU) list to keep the most active blocks in memory to reduce disk I/O. Sequential access, however, can often access inactive data blocks. Placing these inactive blocks at the top of the LRU list can flush active blocks out of the pool, and increase disk I/O.

Aspects of the disclosure pertain to performing an analysis of index read ahead to detect sequential read intention to protect the data buffer pool from being flushed by blocks not likely to be reused.

The index read-ahead can be used to identify up to 16 different data blocks. The index is read ahead until 16 different data blocks are found, or the read ahead buffer is full. Up to 16 data blocks on the same cylinder can be read with a single start I/O instruction. The analysis of the sequential nature of the data blocks can also be used to predict sequential access, and put data blocks at the end of the LRU list, and protect random blocks more likely to be reused from being flushed from the buffer.

Some aspects of the embodiments are directed to a system and method for implementing a dynamic buffer pool to process non-conforming tasks. This process dynamically detects non-conforming tasks (e.g., memory read accesses that use sequential access that have a hit ratio lower than a threshold value) that would disrupt the highly efficient processing of the primary buffer pools and shifts the processing of these tasks to their own private buffer pool for the duration of the non-conforming task.

The set use buffers from the normal random pool can be used until the “hit ratio” for tasks is significantly less than the overall pool hit ratio. If the hit ratio dips below a threshold value, these nonconforming tasks can use a private buffer pool. Sequential access tends to access more inactive blocks that are not likely to be reused, so sequential tasks have a lower hit ratio. The hit ratio can be tracked by tracking how many times the buffer pool is used before it is flushed.

Since separate buffer pools could use a lot of memory, their total size can be controlled by changing the threshold hit ratio to breakout less often, if needed. The index read-ahead block usage can be used to determine the number of buffers to use in a breakout pool. And when the table is the inner table of a nested loop join, remember if it had a private pool and its size.

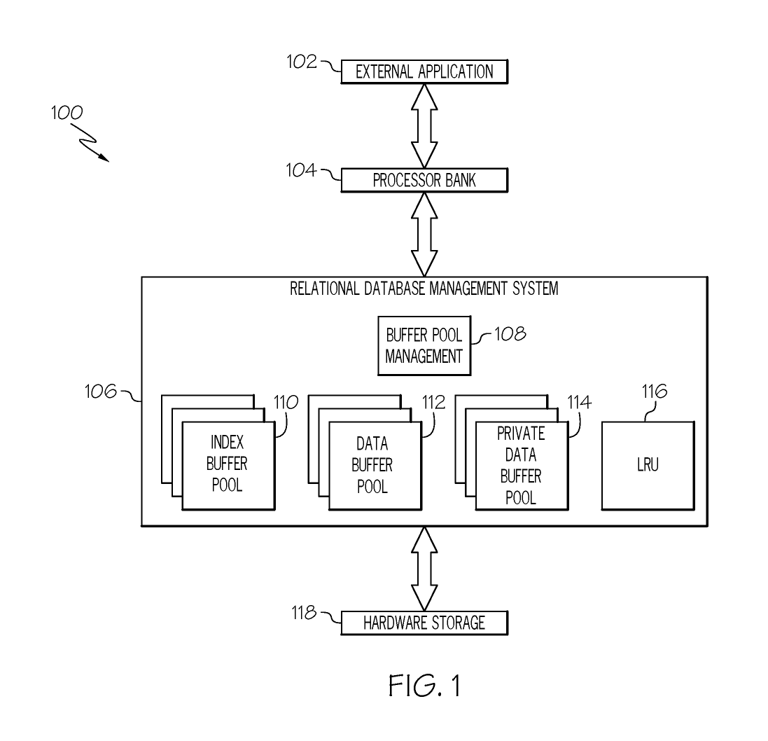

FIG. 1 is a schematic block diagram of an example computing system 100 that includes a buffer pool in accordance with embodiments of the present disclosure. The computing system 100 can be a mainframe computer or server computer that is connected to one or more workstations or terminals. The computing system 100 can provide data storage and retrieval functionality for the one or more connected workstations through an external application 102. The one or more connected workstations can be local devices or remote devices connected across a computer network, such as a wide area network or the Internet. The external application 102 can provide an interface for accessing the computing system 100 through which read and write commands can be exchanged.

The computing system 100 can include a processor bank 104. Processor bank 104 can include one or more hardware processors for processing instructions received from the external application 102. To increase the data retrieval speeds and decrease I/O, the computing system 100 can include a relational database management system (RDBMS) 106 to organize information quickly. A RDBMS 106 can use a structured query language (SQL) to query and maintain the database.

The RDBMS 106 can include a plurality related tables. The same database can be viewed in many different ways. An important feature of relational systems is that a single database can be spread across several tables.

The computing system 106 can include one or more buffer pools, including an index buffer pool 110, a data buffer pool 112, and in some embodiments, a private data buffer pool 114. The buffer pools can act as a data cache for I/O transactions for data stored on hardware storage 118, which can be a disk drive or other storage system. A page of data from the hardware storage 118 is copied to the data buffer pool 112 for I/O transactions. After the I/O transactions are completed, the data buffer pool can be flushed.

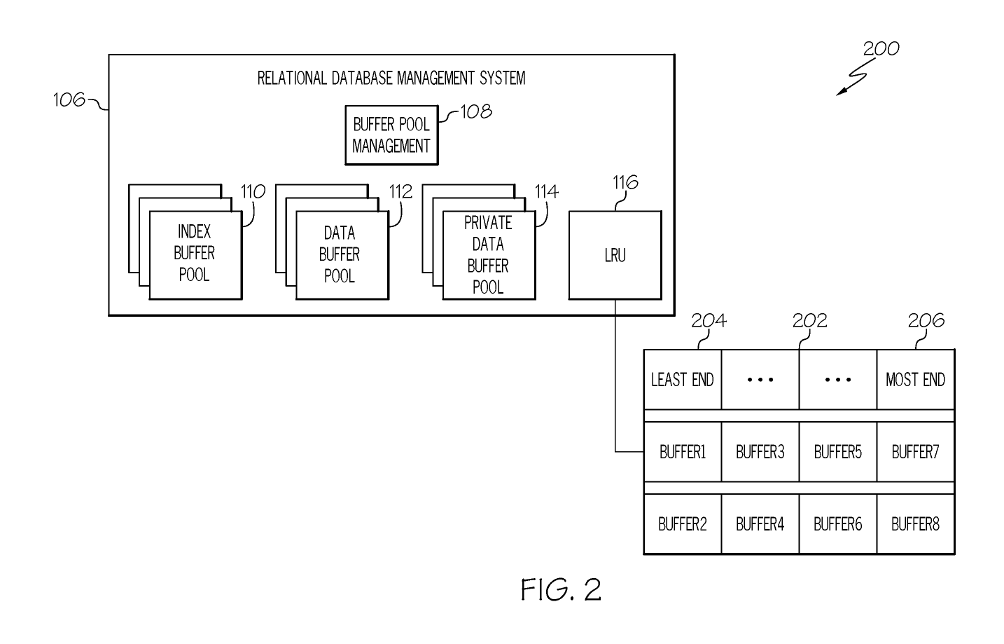

A least recently used (LRU) list 116 can be used as a caching algorithm to organize data in the buffers. An example LRU 116 is illustrated in FIG. 2. FIG. 2 is a schematic block diagram of a relational database management system that includes a least recently used list in accordance with embodiments of the present disclosure. The LRU 116 can be organized as a table 202 that places least recently used blocks at the back (least end 204) and most recently used blocks at the front (most end 206). The LRU 116 will flush a block that is the least recently used. The blocks that are the least recently used can be considered to be at the back (least end 204) of the LRU 116, while the most recently used page can be at the front (most end 206) of the LRU 116. Pages at the rear of the LRU 116 can be the first to be flushed from the cache.

In some embodiments, when using sequential access, the most recently used pages can often be flushed first, since these pages are unlikely to be used again (i.e., inactive blocks). When inactive blocks are placed in LRU 116, they can cause the LRU 116 to flush active blocks that are at or near the back of the LRU 116 (or can push active blocks towards the back of the LRU 116, meaning that these active blocks are likely to be flushed after subsequent transactions). This disclosure describes placing the inactive blocks from a sequential access to the back of the LRU 116, instead of at the front, thereby decreasing the likelihood of flushing active blocks from the cache.

An index read-ahead can be used in either scenario to determine that the data blocks are sequential and determine a number of blocks used in the task. The number of data blocks can be used to determine how much space to use in the LRU 116. The data blocks can be read into the LRU 116 at the back of the LRU 116; or in embodiments, the data blocks can be read normally into the LRU 116 until the last data block is reached, which can be placed at the back of the LRU 116.

In some embodiments, non-conforming tasks that would disrupt the highly efficient processing of the primary buffer pools can be dynamically detected. Instead of, or in addition to, using the LRU 116, a private buffer can be created and used to cache the non-conforming tasks for the duration of the duration of the non-conforming task.

In this embodiment, the data buffers from the normal random pool are used until a “hit ratio” is significantly less than the overall pool hit ratio. When the hit ratio drops below a threshold value, a private buffer pool 114 can be used for processing the non-conforming transactions. (The “hit ratio” can be defined as how often a buffer is already in the pool.) Sequential access tends to access more inactive blocks that are not likely to be reused, so it has a lower hit ratio. The hit ratio can be tracked by tracking how many times the buffer pool is used before it is flushed. Since private buffer pools can use a lot of memory, their total size can be controlled by changing the threshold hit ratio to breakout less often, if needed. The index read-ahead block usage can be used to determine the number of buffers in a breakout pool.

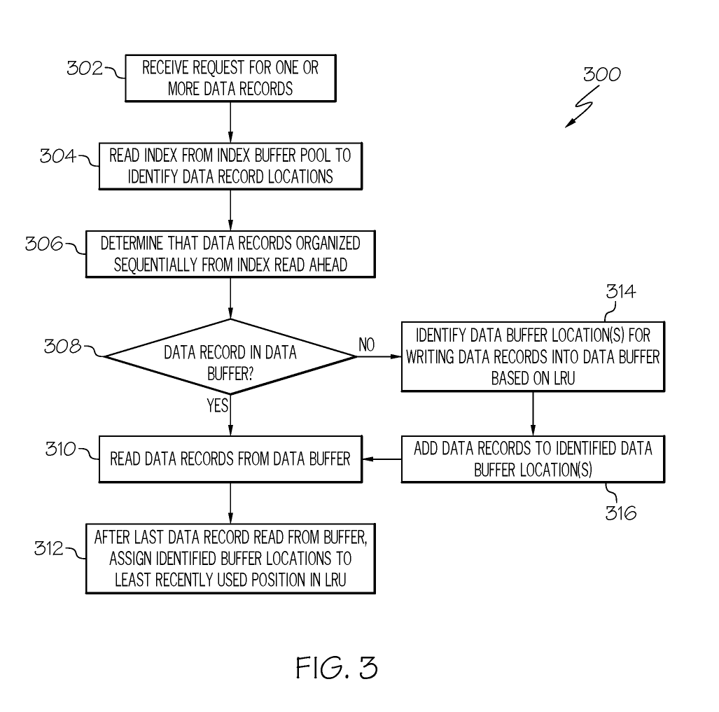

FIG. 3 is a process flow diagram 300 for implementing a dynamic buffer pool to process non-conforming tasks in accordance with embodiments of the present disclosure. A computing system, such as that shown in FIG. 1, can receive a request for one or more data records from an external application (302). The request can be a read or write, and is generalized to be an I/O transaction. A memory manager or relational database management system (RDBMS) can read an index from the index buffer pool to identify data record locations for the one or more data records (304). The memory manager or RDBMS can determine that the data records are organized sequentially from the index read-ahead. The index read-ahead can also be used to determine the number of data blocks in the data record that was requested.

If the data record is in a data buffer, then the data record can be read out of the buffer to satisfy the record request (310). If the data record is not in the data buffer, then an LRU can be used to identify data buffer locations for writing in data records from disk (314), and the records can be added to the buffer (316). After the last data record is read from the buffer, the buffer locations are assigned to a least recently used position in the LRU (312). In some cases, these buffers are flushed first to make room for more active data blocks in the LRU.

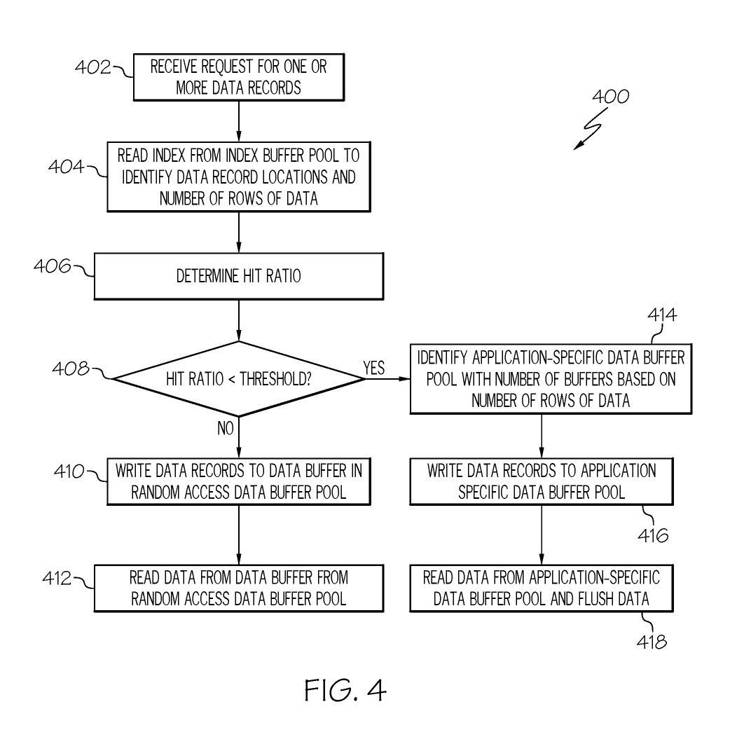

FIG. 4 is a process flow diagram for using sequential read-ahead intention for increasing data buffer reuse in accordance with embodiments of the present disclosure. This process dynamically detects tasks (non-conforming) that would disrupt the highly efficient processing of the primary buffer pools and shift the processing of these tasks to their own private buffer pool for the duration of the non-conforming task.

A computing system, such as that shown in FIG. 1, can receive a request for one or more data records from an external application (402). The request can be a read or write, and is generalized to be an I/O transaction. A memory manager or relational database management system (RDBMS) can read an index from the index buffer pool to identify data record locations for the one or more data records (404).

At some point, for example, prior to, during, or subsequent to receiving a records request from an application, a hit ratio for the buffer can be tracked (406). The hit ratio tracks the number of hits to a buffer the application experiences. One way to track the hit ratio is to determine a number of times a buffer has been used by an application before the buffer is flushed. For example, if nine out of ten rows of data are found in the buffer, then a hit ratio of 9/10 can be used for buffer management.

The hit ratio can be compared to a threshold value (408). If the hit ratio falls below the threshold value, then a private buffer pool (e.g., a temporary buffer used to process the records request) can be used to process the I/O transaction (410). The data records can then be added to the private buffer pool (416) and the I/O transaction can occur from the private buffer pool (418).

The size of the private buffer pool can be based on the number of data records in the I/O transaction, which is discoverable through an index read-ahead. The threshold for the hit ratio comparison can be adjusted to address memory resource limitations. For example, a high threshold value can result in too frequent use of the private buffer pool with little return in I/O transaction efficiency.

If the hit ratio stays above the threshold value, then records are added to the random buffer pool (410), and the I/O transaction can occur from the random buffer pool (412).

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the disclosure. Other embodiments will be apparent to those of ordinary skill in the art from a consideration of the specification or practice of the disclosure disclosed herein. It will also be understood by those of ordinary skill in the art that the scope of the disclosure is not limited to use in a server diagnostic context, but rather that embodiments of the disclosure may be used in any transaction having a need to monitor information of any type. The specification and the described examples are considered as exemplary only, with the true scope and spirit of the disclosure indicated by the following claims.

As indicated above, the network entities that make up the network that is being managed by the network management system are represented by software models in the virtual network machine. The models represent network devices such as printed circuit boards, printed circuit board racks, bridges, routers, hubs, cables and the like. The models also represent locations or topologies. Location models represent the parts of a network geographically associated with a building, country, floor, panel, rack, region, room, section, sector, site, or the world. Topological models represent the network devices that are topologically associated with a local area network or subnetwork. Models can also represent components of network devices such as individual printed circuit boards, ports and the like. In addition, models can represent software applications such as data relay, network monitor, terminal server and end point operations. In general, models can represent any network entity that is of interest in connection with managing or monitoring the network.

The virtual network machine includes a collection of models which represent the various network entities. The models themselves are collections of C++ objects. The virtual network machine also includes model relations which define the interrelationships between the various models. Several types of relations can be specified. A “connects to” relation is used to specify an interconnection between network devices. For example, the interconnection between two workstations is specified by a “connects to” relation. A “contains” relation is used to specify a network entity that is contained within another network entity. Thus for example, a workstation model may be contained in a room, building or local network model. An “executes” relation is used to specify the relation between a software application and the network device on which it runs. An “is part of” relation specifies the relation between a network device and its components. For example, a port model may be part of a board model or a card rack model.

What is claimed is:

1. A computer-implemented method comprising:
identifying one or more data buffer locations from a least recently used (LRU) buffer pool structure for writing data into a data buffer;
writing data into the identified one or more data buffer locations;
reading the data from the one or more data buffer locations; and
assigning the one or more data buffer locations to a least recently used buffer locations in the LRU.

2. The computer-implemented method of claim 1, further comprising:
determining that new data is to be read into the data buffer;
identifying the one or more least recently used buffer locations in the LRU;
flushing data contained in the identified one or more least recently used buffer locations; and
reading the new data into the data buffer at the data buffer locations identified as one or more least recently used buffer locations in the LRU.

3. The computer-implemented method of claim 1, further comprising:
reading one or more indexes from an index buffer pool to identify one or more data records in response to a request for data;
determining, based on the one or more indexes, that the one or more data records is not present in the data buffer; and
retrieving the one or more data records from a storage device for reading into the data buffer.

4. The computer-implemented method of claim 3, wherein reading one or more indexes comprises:
performing a read ahead of the one or more indexes from the index buffer pool; and
determining that the data to be read is organized as sequential data blocks.

5. The computer-implemented method of claim 4, wherein the sequential data blocks comprise a plurality of sequentially organized rows of data; and wherein the method comprises:
identifying a number of sequential rows in the data buffer for writing the sequentially organized rows of data; and
after the sequentially organized rows of data are read from the data buffer, assigning the number of sequential rows as least recently used within the LRU.

6. The computer-implemented method of claim 1, further comprising assigning the identified one or more data buffer locations to a most recently used position in the LRU prior to reading the data from the identified one or more data buffer locations; and wherein:
assigning the one or more data buffer locations to the least recently used buffer locations in the LRU comprises assigning the one or more data buffer locations to the least recently used buffer locations after reading all of the data from the identified one or more data buffer locations.

7. A non-transitory computer-readable medium having program instructions stored therein, wherein the program instructions are executable by a computer system to perform operations comprising:
identifying one or more data buffer locations from a least recently used (LRU) buffer pool structure for writing data into a data buffer;
writing data into the identified one or more data buffer locations;
reading the data from the one or more data buffer locations; and
assigning the one or more data buffer locations to a least recently used buffer locations in the LRU.

8. The non-transitory computer-readable medium of claim 7, the operations further comprising:
determining that new data is to be read into the data buffer;
identifying the one or more least recently used buffer locations in the LRU;
flushing data contained in the identified one or more least recently used buffer locations; and
reading the new data into the data buffer at the data buffer locations identified as one or more least recently used buffer locations in the LRU.

9. The non-transitory computer-readable medium of claim 7, the operations further comprising:
reading one or more indexes from an index buffer pool to identify one or more data records in response to a request for data;
determining, based on the one or more indexes, that the one or more data records is not present in the data buffer; and
retrieving the one or more data records from a storage device for reading into the data buffer.

10. The non-transitory computer-readable medium of claim 9, wherein reading one or more indexes comprises:
performing a read ahead of the one or more indexes from the index buffer pool; and
determining that the data to be read is organized as sequential data blocks.

11. The non-transitory computer-readable medium of claim 10, wherein the sequential data blocks comprise a plurality of sequentially organized rows of data; and wherein the method comprises:
identifying a number of sequential rows in the data buffer for writing the sequentially organized rows of data; and
after the sequentially organized rows of data are read from the data buffer, assigning the number of sequential rows as least recently used within the LRU.

12. The non-transitory computer-readable medium of claim 7, the operations further comprising assigning the identified one or more data buffer locations to a most recently used position in the LRU prior to reading the data from the identified one or more data buffer locations; and wherein:
assigning the one or more data buffer locations to the least recently used buffer locations in the LRU comprises assigning the one or more data buffer locations to the least recently used buffer locations after reading all of the data from the identified one or more data buffer locations.

13. A system comprising:
a hardware processor; and
a memory coupled to the hardware processor, the memory for storing data;
the hardware processor to:
identify one or more data buffer locations from a least recently used (LRU) buffer pool structure for writing data into a data buffer;
write data into the identified one or more data buffer locations;
read the data from the one or more data buffer locations; and
assign the one or more data buffer locations to a least recently used buffer locations in the LRU.

14. The system of claim 13, the hardware processor to:
determine that new data is to be read into the data buffer;
identify the one or more least recently used buffer locations in the LRU;
flush data contained in the identified one or more least recently used buffer locations; and
read the new data into the data buffer at the data buffer locations identified as one or more least recently used buffer locations in the LRU.

15. The system of claim 13, the operations further comprising:
reading one or more indexes from an index buffer pool to identify one or more data records in response to a request for data;
determining, based on the one or more indexes, that the one or more data records is not present in the data buffer; and
retrieving the one or more data records from a storage device for reading into the data buffer.

16. The system of claim 15, wherein reading one or more indexes comprises:
performing a read ahead of the one or more indexes from the index buffer pool; and
determining that the data to be read is organized as sequential data blocks.

17. The system of claim 16, wherein the sequential data blocks comprise a plurality of sequentially organized rows of data; and wherein the method comprises:
identifying a number of sequential rows in the data buffer for writing the sequentially organized rows of data; and
after the sequentially organized rows of data are read from the data buffer, assigning the number of sequential rows as least recently used within the LRU.

18. The system of claim 13, the hardware processor further to assign the identified one or more data buffer locations to a most recently used position in the LRU prior to reading the data from the identified one or more data buffer locations; and wherein:
assigning the one or more data buffer locations to the least recently used buffer locations in the LRU comprises assigning the one or more data buffer locations to the least recently used buffer locations after reading all of the data from the identified one or more data buffer locations.
